(19) United States
(12) Patent Application Publication
(10) Pub. No.: US 2002/0194030 A1
(43) Pub. Date: Dec. 19, 2002

(54) Method and system for ascertaining an institution for making a medical assessment

(76) Inventors: Tilo Christ, Erlangen (DE); Siegfried Schneider, Erlangen (DE); Hans Schull, Weisendorf (DE); Gudrun Zahlmann, Neumarkt (DE); Heinz Prihoda, Heroldsberg (DE); Volker Schmidt, Erlangen (DE); Werner Striebel, Lauf (DE)

Correspondence Address: LYON & LYON LLP, 633 WEST FIFTH STREET, SUITE 4700, LOS ANGELES, CA, 90071, US

(21) Appl. No.: 09/923,430

(22) Filed: Aug. 8, 2001

(30) Foreign Application Priority Data
Jun. 13, 2001 (DE) 101 28 524.8

(51) Int. Cl. G06F 17/60

(52) U.S. Cl. 705/3

(57) ABSTRACT

The invention relates to a method and to a system for ascertaining a suitable institution for making a medical assessment on the basis of a medical data record of a patient.

### FIELD OF THE INVENTION

The invention relates to a method and to a system for ascertaining a suitable institution for making a medical assessment on the basis of a medical data record of a patient.

### BACKGROUND OF THE INVENTION

Sometimes, a doctor examining a patient is not certain of whether a diagnosis which he makes for the patient is correct. He can then send a medical data record which he has ascertained while examining the patient to another doctor, so that this doctor can provide him with a medical assessment of the patient. An example of such a procedure is when a general practitioner takes an X-ray image of the patient's lung and is undecided about the diagnosis, because he is not a pulmonary expert. He can then send the X-ray image, for example, to a pulmonary expert, so that this expert makes the medical assessment. However, it is not always possible to find a suitable expert, in particular quickly and easily, who is able to make the medical assessment.

An advantage of the invention is in providing a precondition that a suitable institution for making a medical assessment on the basis of available medical data is easily ascertained.

### SUMMARY OF THE INVENTION

The invention provides a method for ascertaining a suitable institution making a medical assessment on the basis of a medical data record of a patient, including the steps of sending to or receiving at a central location a first order for a first medical assessment to be made for a first patient from a first location, and ascertaining from a set of institutions, on the basis of the first order, the suitable institution for making a first medical assessment on the basis of the first order. The invention also provides a computerized system configured to carry out the method.

### BRIEF DESCRIPTION OF THE DRAWINGS

Other advantages, features and details of the invention can be found in the illustrative embodiments of the invention which are described below with reference to the drawings, in which:

FIG. 1 shows a scenario suitable for illustrating the inventive method,

FIG. 2 shows an inventive system, and

FIGS. 3 to 5 show flow charts to illustrate the inventive method.

### DETAILED DESCRIPTION OF THE INVENTION

A first medical data record for the first patient is thus available at the first location, but the associated first medical assessment needs to be made at another location. It is therefore necessary to find the suitable institution making the first medical assessment on the basis of the first medical data record. This is necessary, for example, when, as already described above, a doctor is undecided about a diagnosis which he has made and would like to obtain a second opinion, in particular from an expert. According to the invention, the first order is then sent from the first location, which is the medical practice of the aforementioned doctor, for example, to the central location. The suitable institution which is able to make the first medical assessment on the basis of the order is then ascertained at the central location. The suitable institution can be ascertained automatically, for example, using a suitable data processing installation. This means that the aforementioned doctor need approach only one place when he would like to have a medical assessment made, which is particularly advantageous if he would like to have a plurality of medical assessments made.

If the suitable institution has been ascertained at the central location, then, in accordance with one embodiment of the invention, the identity of the ascertained institution can be sent from the central location to the first location, so that the first medical data record of the first patient can be sent from the first location to the institution for the purpose of making the first medical assessment. The first medical data record is, by way of example, an X-ray image of the patient taken by the doctor, which he then sends to the institution cited to him, whereupon the institution is able to make the first medical assessment.

In accordance with another variant of the invention, the first order actually comprises this first medical data record, so that the first medical data record is forwarded from the central location to the ascertained institution for the purpose of making the first medical assessment. This means that the doctor, for example, need not contact the suitable institution himself, which saves him valuable time. It is also possible for the identity of a person placing the order, that is to say the orderer, to remain unknown to the institution.

In accordance with one embodiment of the invention, after being sent to the central location, the first order is entered in a list, the list comprising orders for which no suitable institution has yet been ascertained in each case, and the list being able to be inspected by institutions from the set of institutions in order to send an offer for making the medical assessment to the central location. The institutions thus have the opportunity to inform themselves about orders which have been sent to the central location but have not yet been forwarded to an institution. These institutions can then send an offer for making the medical assessment to the central location.

In accordance with one advantageous variant of the invention, the list can be retrieved over the Internet.

Once the ascertained institution has made the first medical assessment, it is able, according to embodiments of the invention, to send the first medical assessment directly to the first location or to the central location, so that the medical assessment is forwarded from the central location to the first location. It is particularly advantageous for the institution to send the first medical assessment to the central location when it has made a plurality of medical assessments for various orderers. This is because it then need not send a plurality of medical assessments to various locations, but instead can send the medical assessments bundled together to the central location. In addition, the identity of the institution can be kept secret from the orderer.

In accordance with one embodiment of the invention, the institution is a doctor, a team of doctors and/or a hospital. Thus, by way of example, a doctor or a team of doctors can specialize in making medical assessments for further persons.

In accordance with one particularly preferred variant of the invention, the first medical data record comprises an associated image, video film, laboratory results, ECG and/or patient file of the first patient. In this context, in accordance with one embodiment of the invention, the image is taken by a medical imaging apparatus which, in accordance with a particularly preferred embodiment of the invention, is a computer tomograph, a magnetic resonance apparatus, an ultrasound apparatus or an X-ray apparatus.

The inventive method can be carried out particularly practically and efficiently if, in accordance with variants of the invention, the first order, the first medical data record and/or the first medical assessment are sent over a data network. Such a data network is the Internet, for example.

In accordance with one particularly preferred embodiment of the invention, the suitable institution is ascertained at the central location on the basis of at least one criterion.

In accordance with one variant of the invention, the criterion may be a demanded quality for the first medical assessment made, a medical specialization of the institution, a period of time for making the first medical assessment, a number of medical assessments which the institution can make in a prescribed period of time, the fee demanded by the institution for making the first medical assessment, and/or legal regulations. It is therefore possible to guarantee, for example, that the ascertained institution makes a high-quality first medical assessment or, if necessary, makes the first medical assessment quickly, and that an inexpensive institution is ascertained for making the first medical assessment.

Alternatively, in accordance with one embodiment of the invention, the criterion may be a quality of the first medical data record sent from the first location to the central location.

If, in accordance with one embodiment of the invention, a service provided by the ascertained institution is monitored at the central location, a precondition is provided that the ascertained institution makes constant medical assessments of high quality.

In accordance with one variant of the invention, the service provided may be a quality of the first medical assessment made, adherence to a prescribed period of time for making the first medical assessment, and/or adherence to the making of a prescribed number of medical assessments.

The inventive method can be carried out particularly practically for the orderer or for the institution making the first medical assessment if an invoice for the first medical assessment made is produced at the central location and is sent to the first location. This is particularly practical if the institution is making a large number of medical assessments or if the first location is sending a large number of medical data records for various patients.

In accordance with one preferred variant of the invention, the first order sent from the first location to the central location is an order for making a plurality of medical assessments for a plurality of patients which comprises medical data records required for making medical assessments, and the medical assessments are made by one institution or by a plurality of institutions from the set of institutions. Particularly when a person orders a large number of medical assessments to be made, one institution may not be able to make all the assessments, particularly in a demanded time. It is then particularly advantageous if the first order is split into a plurality of smaller orders at the central location and is forwarded to a plurality of institutions.

In accordance with another preferred embodiment of the invention, a second location additionally sends a second order for making a second medical assessment of a second patient to the central location, the second order comprising a second medical data record of the second patient, which second medical data record is required for making the second medical assessment, and the first and second orders are placed with an institution from the set of institutions by the central location as a collective order for making the first and second medical assessments, and the first and second medical data records are sent from the central location to the institution. This is particularly advantageous when an institution gives a discount on price if it receives an order for making a plurality of medical assessments.

The object of the invention is also achieved by a system for ascertaining a suitable institution making a medical assessment on the basis of a medical data record for a patient, having a database which is arranged at a central location and can be contacted by an orderer over a data network in order to ascertain the suitable institution, so that the orderer is able to send to the database an order comprising the medical data record for the purpose of ascertaining the suitable institution, means for storing data from a set of institutions, and means for comparing the order with the data which are stored in the means for storing data from a set of institutions. The inventive system is thus designed such that it can also be used to carry out the inventive method.

Advantageous refinements of the invention can be found in the dependent claims.

An exemplary embodiment is illustrated by way of example in the schematic drawings.

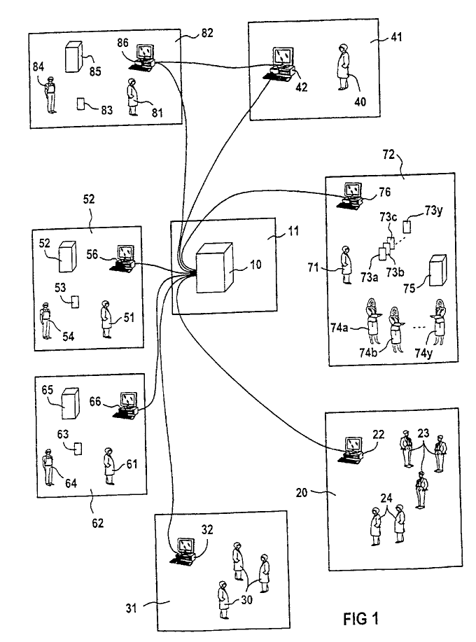

FIG. 1 shows a database 10 which is connected to the Internet in the case of the present exemplary embodiment and is located in a business office 11 of a telemedical service provider, and is also operated by the telemedical service provider.

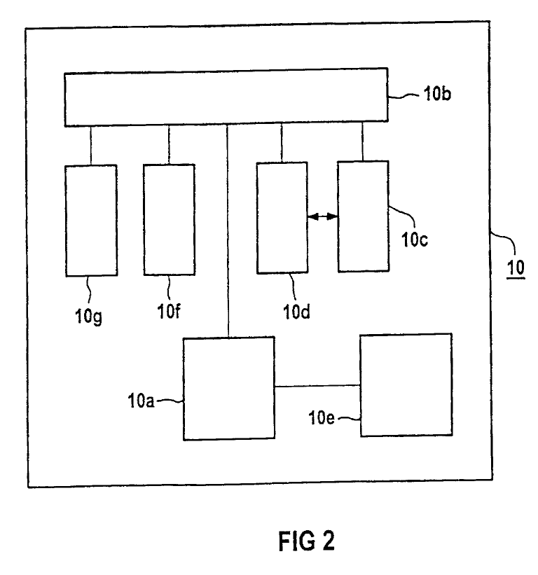

The database 10 stores a suitable computer program which, on the basis of data stored in the database 10 and on the basis of an order sent to the database 10, ascertains a suitable institution which is able to make a medical assessment demanded on the basis of the order. One possible design for the database 10 and for the computer program stored in the database 10 is shown by way of example and schematically in FIG. 2.

When an order is sent to the database 10, the order is first stored in a memory module 10a. An arrangement module 10b then compares the sent order stored in the memory module 10a with a service catalog 10c stored in the database 10. The service catalog 10c includes details of services guaranteed by institutions which make medical assessments and whose identities are stored in a registration module 10d. In the case of the present exemplary embodiment, the services include a detail about the specialization of the institution, a period of time which the institution requires for making a medical assessment, a number of medical assessments which the institution is able to make within a prescribed period of time, a fee which the institution charges for making the medical assessment, and those countries for which the institution is legally permitted to make a medical assessment.

The database 10 also stores a list, which can be inspected over the Internet, in the form of an Internet page in which the orders sent to the database 10 are automatically entered. In the case of the present exemplary embodiment, the list can be inspected over the Internet by the institutions stored in the registration module 10d, so that the institutions can independently send to the database 10 an offer for making a medical assessment on the basis of one of the orders stored in the list. When an order has been placed with one of the institutions by the database 10, this order is automatically removed from the list again.

In the case of the present exemplary embodiment, FIG. 1 shows a hospital 20, a team of doctors 30 and a cephalic specialist 40 as a selection of institutions which make medical assessments and whose identities are stored in the registration module 10d.

The database 10 also comprises a forwarding module 10e in which the order sent to the database 10 is forwarded to the ascertained institution if required. Furthermore, the forwarding module 10e is designed such that, if desired, the identity of the orderer is not given away to the ascertained institution. Personal data for those persons for whom the medical assessment is to be made is also kept anonymous in the forwarding module 10e.

The memory and forwarding modules 10a and 10e are also provided in order to store the medical assessment which is made by the institution and is sent to the database 10, and to forward it to the orderer. The identity of the institution can also be kept secret.

An accounting module 10f in the database 10 can be used to produce an invoice for the orderer on the basis of the data stored in the service catalog 10c. The invoice includes a fee for ascertaining the suitable institution and, if necessary, for forwarding the order, and a fee for making the medical assessment. The accounting module 10f is also provided in order to start paying the ascertained institution for making the medical assessment.

So that the telemedical service provider can ensure a consistently high quality for medical assessments made, the database 10 comprises a quality module 10g, on the basis of which, in the case of the present exemplary embodiment, orderers are randomly asked whether they are satisfied with the quality of the medical assessments made. In addition, the quality module 10g has medical assessments randomly made by various institutions on the basis of the same medical data record and compares whether the medical assessments made are comparable, that is to say at least come to similar conclusions.

Should the computer program stored in the database 10 not be able to ascertain any suitable institution on the basis of an order, it sends an appropriate message to the orderer.

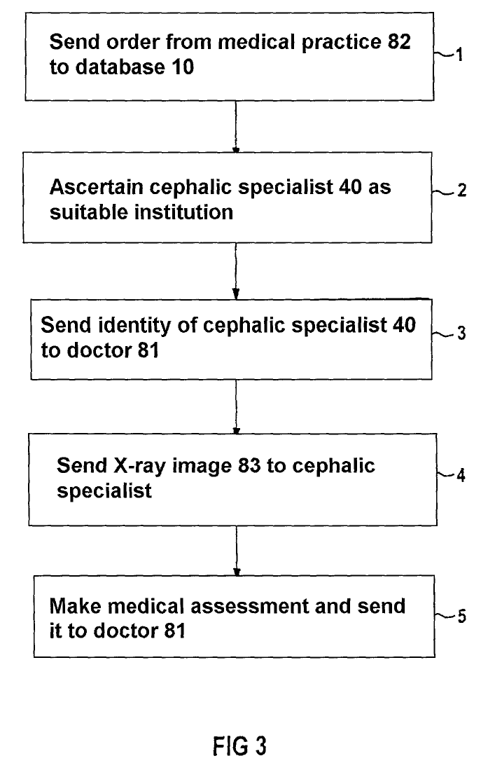

FIG. 1 also shows a doctor 81 in his medical practice 82 who has taken an X-ray image 83 of a patient 84 using an X-ray apparatus 85 located in the medical practice 82. In the case of the present exemplary embodiment, the X-ray image 83 is an X-ray image 83 of the head of the patient 84. Since, in the case of the present exemplary embodiment, the doctor 81 is undecided about an interpretation of the X-ray image 83, he uses a computer 86 which is located in his medical practice 82 and is connected to the Internet to contact the database 10, and sends an order to the database 10 indicating that he is searching for a suitable institution which is able to make a medical assessment on the basis of the X-ray image 83 which he has available. The doctor 81 also indicates that the X-ray image 83 is an X-ray image of a head and that he would like to have the medical assessment within two days (step 1 of the flow chart shown in FIG. 3).

In the case of the present exemplary embodiment, the computer program stored in the database 10 ascertains, on the basis of the details of the order from the doctor 81 and on the basis of the data stored in the service catalog 10c and the registration module 10d, that the cephalic specialist 40 is able to make a medical assessment within two days, whereupon the database 10 sends a message including the identity of the cephalic specialist 40 to the computer 86 (steps 2 and 3 of the flow chart shown in FIG. 3). The doctor 81 then contacts the cephalic specialist 40 and instructs him to make a medical assessment on the basis of the X-ray image 83 of the patient 84. So that the cephalic specialist 40 receives the X-ray image 83, the doctor 81 uses his computer 86 to send an image data record associated with the X-ray image 83 to a computer 42, connected to the Internet, over the Internet (step 4 of the flow chart shown in FIG. 3). The computer 42 is located in a medical practice 41 of the cephalic specialist 40, so that the cephalic specialist is able to evaluate the X-ray image 83 associated with the image data record which has been sent and can then make the medical assessment of the patient 84. Once the cephalic specialist 40 has made the medical assessment, he uses his computer 42 to send a data record associated with the medical assessment to the computer 86 of the doctor 81 (step 5 of the flow chart shown in FIG. 3).

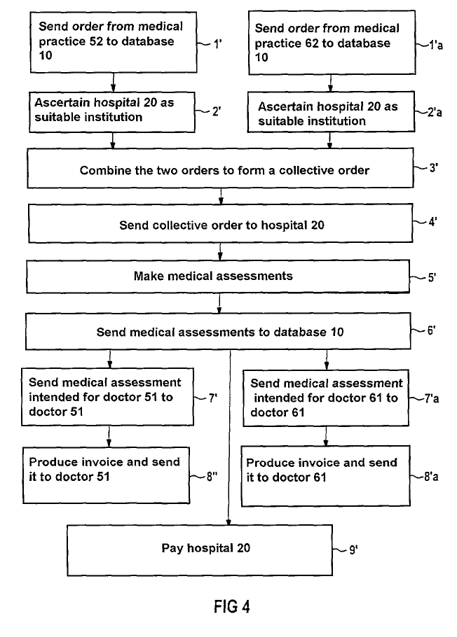

FIG. 1 also shows another doctor 51, who has taken an X-ray image 53 of a patient 54 using an X-ray apparatus 55 located in his medical practice 52. In the case of the present exemplary embodiment, the X-ray image 53 is an X-ray image 53 of the lung of the patient 54. In the case of the present exemplary embodiment, the doctor 51 is likewise undecided about a diagnosis, so that he uses a computer 56 which is located in his medical practice 52 and is connected to the Internet to send an order to the database 10, indicating that he wishes to have a medical assessment made. In the case of the present exemplary embodiment, the order comprises an image data record associated with the X-ray image 53 (step 1′ of the flow chart shown in FIG. 4).

FIG. 1 also shows another doctor 61, who has taken an X-ray image 63 of a patient 64 using an X-ray apparatus 65 located in his medical practice 62. In the case of the present exemplary embodiment, the X-ray image 63 is likewise an X-ray image 63 of the lung of the patient 64. The doctor 61 is likewise undecided about a diagnosis, so that he uses a computer 66 which is located in his medical practice 62 and is connected to the Internet to send an order to the database 10, indicating that he wishes to have a medical assessment made. The order also comprises an image data record associated with the X-ray image 63 (step 1′a of the flow chart shown in FIG. 4).

In the case of the present exemplary embodiment, the computer program stored in the database 10 recognizes that the two doctors 51 and 61 each wish to have a medical assessment made on the basis of an X-ray image 53 or 63 of a lung. On the basis of the data stored in the service catalog 10c and the registration module 10d, the arrangement module 10b of the computer program ascertains that pulmonary experts 23 work for the hospital 20. In addition, the hospital 20 offers to make a medical assessment on the basis of X-ray images of a lung particularly inexpensively if the order comprises making a plurality of medical assessments (steps 2′ and 2′a of the flow chart shown in FIG. 4).

The computer program stored in the database 10 therefore combines the two orders from the doctors 51 and 61 to form a collective order and sends the collective order to a computer 22 which is located in the hospital 20 and is connected to the Internet (steps 3′ and 4′ of the flow chart shown in FIG. 4). The collective order additionally comprises the image data records which are associated with the X-ray images 53 and 63 and are stored in the memory module 10a on the basis of the orders sent by the doctors 51 and 61. The pulmonary experts 23 then make a respective medical assessment on the basis of the collective order and send the medical assessments made to the database 10 using the computer 22 (step 5′ and 6′ of the flow chart shown in FIG. 4).

The computer program stored in the database 10 then sends the medical assessment intended for the doctor 51 to the computer 56 of the doctor 51 (step 7′ of the flow chart shown in FIG. 4) and sends the medical assessment intended for the doctor 61 to the computer 66 of the doctor 61 (step 7′a of the flow chart shown in FIG. 4).

On the basis of the data stored in the accounting module 10f, the computer program stored in the database 10 then produces a respective invoice for the doctors 51 and 61 for arranging the hospital 20 to be the institution which made a medical assessment for the doctors 51 and 61. The invoices also include a fee for making the medical assessments. The respective invoice is then sent to the computer 56 or 66 (steps 8′ and 8′a of the flow chart shown in FIG. 4). When the doctors 51 and 61 have each settled their invoice, the computer program stored in the database 10 arranges, on the basis of the data stored in the accounting module 10f that the hospital 20 is paid for the medical assessments made (step 9′ of the flow chart shown in FIG. 4).

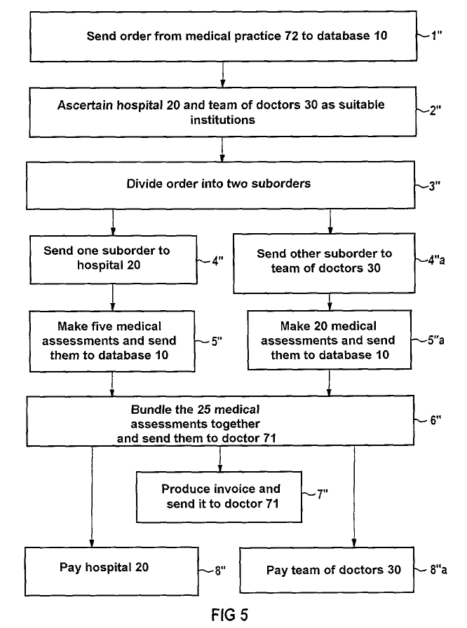

FIG. 1 also shows another doctor 71, who performs mammography screenings. For this purpose, he has a suitable X-ray apparatus 75 which is located in his medical practice 72. In the case of the present exemplary embodiment, the doctor 71 performs, on average, 25 mammography examinations daily, which means that, on average, he produces 25 mammograms 73a to 73y for 25 patients 74a to 74y daily using the X-ray apparatus 75. For time reasons, the doctor 71 is not able to evaluate the mammograms 73a to 73y himself, so that, in the case of the present exemplary embodiment, he uses a computer 76 which is located in the medical practice 72 and is connected to the Internet to send to the database 10 an order for making 25 medical assessments on the basis of the 25 mammograms 73a to 73y. The order from the doctor 71 also comprises image data records associated with the 25 mammograms 73a to 73y (step 1″ of the flow chart shown in FIG. 5).

On the basis of the order from the doctor 71, the computer program stored in the database 10 ascertains that a team of doctors 30 specializes in making a medical assessment on the basis of a mammogram. However, the team of doctors 30 can make only 20 medical assessments daily. In addition, the computer program stored in the database 10 ascertains that other doctors 24 are employed in the hospital 20 who are likewise able to make a medical assessment on the basis of a mammogram. The doctors 24 in the hospital 20 can make approximately 10 medical assessments daily (step 2″ of the flow chart shown in FIG. 5).

The computer program stored in the database 10 then divides the order from the doctor 71 into two sub-orders and instructs the hospital 20 to make 5 medical assessments, and instructs the team of doctors 30 to make 20 medical assessments (step 3″ of the flow chart shown in FIG. 5). The database 10 therefore sends to the computer 22 in the hospital 20 five image data records having five associated mammograms (step 4″ of the flow chart shown in FIG. 5). In addition, the database 10 sends image data records having 20 associated mammograms from among the mammograms 73a to 73y to a computer 32 which is located in a medical center 31 for the team of doctors 30 and is connected to the Internet (sept 4″a of the flow chart shown in FIG. 5).

Once the doctors 24 have made their five medical assessments and the team of doctors 30 has made its 20 medical assessments, they both send their medical assessments to the database 10 (steps 5″ and 5″a of the flow chart shown in FIG. 5). The database 10 bundles the 25 medical assessments together and then sends them to the computer 76 of the doctor 71 again, so that this doctor can read the 25 medical assessments (step 6″ of the flow chart shown in FIG. 5).

On the basis of the data stored in the accounting module 10f, the computer program stored in the database 10 then produces an invoice for the doctor 71 for arranging the hospital 20 and the team of doctors 30 to be the suitable institutions. The invoice also includes a fee for making the medical assessments. The invoice is then sent to the computer 76 (step 7″ of the flow chart shown in FIG. 5). The computer program stored in the database 10 arranges that the hospital 20 and the team of doctors 30 are paid on the basis of the data stored in the accounting module 10f (steps 8″ and 8″a of the flow chart shown in FIG. 5).

In the exemplary embodiment described, the image data records associated with the various X-ray images 53, 63 and 83 and with the mammograms 73a to 73y are medical data records. A medical data record can also comprise other details, however. In particular, it may be associated with a laboratory result, a video film or a patient file of a patient. The image data record may also be associated with an image other than an X-ray image. The image may, in particular, have been taken using a computer tomograph, a magnetic resonance apparatus or using an ultrasound apparatus. The medical data record may also be associated with an ECG.

The data network used for sending the order, the medical assessment or the medical data record need not necessarily be the Internet. In particular, a telephone network may also be used.

While embodiments of the invention have been described above, many more embodiments are within the scope of the invention as set forth in the following claims.

We claim:

1. A computerized method for ascertaining a suitable institution making a first medical assessment on the basis of a first medical data record of a first patient, comprising the steps of:
a) receiving at a central location a first order for the first medical assessment to be made for the first patient from a first location, and
b) ascertaining from a set of institutions, on the basis of the first order, the suitable institution for making the first medical assessment on the basis of the first order.

2. The method as claimed in claim 1, further comprising the steps of sending the identity of the ascertained institution from the central location to the first location, wherein the first medical data record of the first patient may be sent to the ascertained institution for the purpose of making the first medical assessment.

3. The method as claimed in claim 1, wherein the first order comprises the first medical data record of the first patient, further comprising the step of forwarding the first medical data record from the central location to the ascertained institution for the purpose of making the first medical assessment.

4. The method as claimed in claim 1, further comprising, after the sending step, the step of entering the first order in a list, the list comprising orders for which no suitable institution has yet been ascertained in each case, and the list being able to be inspected by institutions from the set of institutions in order to send an offer for making the medical assessment to the central location.

5. The method as claimed in claim 4, in which the list can be retrieved over the Internet.

6. The method as claimed in claim 1, further comprising the step of the ascertained institution sending the first medical assessment made to the first location.

7. The method as claimed in claim 1, further comprising the steps of the ascertained institution sending the first medical assessment made to the central location, and the first medical assessment made being forwarded from the central location to the first location.

8. The method as claimed in claim 1, wherein the institution is a doctor, a team of doctors and/or a hospital.

9. The method as claimed in claim 2, wherein the first medical data record has an associated image, video film, laboratory results for the patient, ECG and/or patient file for the first patient.

10. The method as claimed in claim 3, wherein the first medical data record has an associated image, video film, laboratory results for the patient, ECG and/or patient file for the first patient.

11. The method as claimed in claim 10, wherein the associated image has been taken using a medical imaging apparatus.

12. The method as claimed in claim 11, in which the medical imaging appliance is a computer tomograph, a magnetic resonance apparatus, an ultrasound apparatus or an X-ray apparatus.

13. The method as claimed in claim 1, wherein the first order is sent over a data network.

14. The method as claimed in claim 1, wherein the first medical data record and/or the first medical assessment are sent over a data network.

15. The method as claimed in claim 1, wherein the suitable institution is ascertained at the central location on the basis of at least one criterion.

16. The method as claimed in claim 15, in which the criterion is a demanded quality for the first medical assessment made, a medical specialization of the institution, a period of time for making the first medical assessment, a number of medical assessments which the institution can make in a prescribed period of time, the fee demanded by the institution for making the first medical assessment, and/or legal regulations.

17. The method as claimed in claim 15, in which the criterion is a quality of the first medical data record received at the central location from the first location.

18. The method as claimed in claim 1, further comprising the step of monitoring at the central location a service provided by the ascertained institution.

19. The method as claimed in claim 18, in which the service provided is a quality of the first medical assessment made, adherence to a prescribed period of time for making the first medical assessment, and/or adherence to the making of a prescribed number of medical assessments.

20. The method as claimed in claim 1, further comprising the steps of generating an invoice for the first medical assessment made at the central location and sending the invoice to the first location.

21. The method as claimed in claim 1, wherein the first order received at the central location from the first location is an order for making a plurality of medical assessments for a plurality of patients, wherein the first order comprises medical data records required for making medical assessments, and wherein the medical assessments are made by one institution or by a plurality of institutions from the set of institutions.

22. The method as claimed in claim 3, further comprising the steps of receiving at the central location a second order for making a second medical assessment of a second patient from a second location, the second order comprising a second medical data record of the second patient, which second medical data record is required for making the second medical assessment, the central location placing the first and second orders with an institution from the set of institutions as a collective order for making the first and second medical assessments, and sending the first and second medical data records from the central location to the institution.

23. A system for ascertaining a suitable institution for making a medical assessment on the basis of a medical data record of a patient, comprising a database which is arranged at a central location configured to be contacted by an orderer over a data network in order to ascertain the suitable institution, so that the orderer is able to send to the database an order comprising the medical data record for the purpose of ascertaining the suitable institution, means for storing data from a set of institutions, and means for comparing the order with the data which are stored in the means for storing data from a set of institutions.

24. The system as claimed in claim 23, further comprising forwarding means configured to forward the medical data record to the ascertained institution.

25. The system as claimed in claim 23, further comprising means for producing an invoice wherein the invoice producing means is configured to produce an invoice for ascertaining the suitable institution and send the invoice to the orderer.

26. The system as claimed in claim 23, further comprising means for checking the quality of the medical assessment made by the institution.

27. A system, comprising a database operatively coupled to a central processor, wherein the system is configured to:
a) store data for a set of institutions,
b) receive from a first location a first order for a first medical assessment to be made for a first patient, wherein the first order comprises a first medical data record of the first patient,
c) compare the first order with the stored data for the set of institutions,
b) select an institution from the set of institutions based on the comparison, wherein the selected institution is suitable for making a medical assessment of the first patient, and
c) forward the first medical data record to the selected institution.

28. A computerized method, comprising the steps of:
a) receiving at a central location from a first location a first order for a first medical assessment to be made for a first patient, wherein the first order comprises a first medical data record of the first patient,
b) based on the first order and the first medical data record, selecting at the central location an institution from a set of institutions, wherein the selected institution is suitable for making a medical assessment of the first patient, and
c) forwarding the first medical data record from the central location to the suitable institution.
